(19) United States
(12) Patent Application Publication
(10) Pub. No.: US 2026/0005291 A1
(43) Pub. Date: Jan. 1, 2026

(54) SURFACE-MODIFIED COMPOSITE SOLID ELECTROLYTE AND PREPARING METHOD THEREOF

(71) Applicant: SEOUL NATIONAL UNIVERSITY R&DB FOUNDATION, Seoul (KR)

(72) Inventors: Kyu Tae LEE, Seoul (KR); Kanghyeon KIM, Seoul (KR); Taehun KIM, Seoul (KR); Gawon SONG, Seoul (KR)

(21) Appl. No.: 19/105,980

(22) PCT Filed: Jan. 4, 2024
(86) PCT No.: PCT/KR2024/000182

§ 371 Date: Feb. 24, 2025

(30) Foreign Application Priority Data
Mar. 7, 2023 (KR) 10-2023-0030078

(51) Int. Cl. H01M 10/056; H01M 4/505; H01M 4/525; H01M 4/62; H01M 10/0525

(52) U.S. Cl. CPC H01M 10/056; H01M 4/505; H01M 4/525; H01M 4/625; H01M 10/0525; H01M 2300/0068; H01M 2300/0094

(57) ABSTRACT

Disclosed is a surface-modified composite solid electrolyte including a sulfide-based solid electrolyte particle; and a coating film formed on the surface of the sulfide-based solid electrolyte particle, the coating film containing a functional group derived from a chalcogenide-based compound represented by a chemical formula 1, and a method for preparing same.

### TECHNICAL FIELD

### Cross-Reference to Related Application

This application claims the benefit of priority to Korean Patent Application No. 10-2023-0030078, filed in the Korean Intellectual Property Office on Mar. 7, 2023, the entire contents of which are incorporated herein by reference.

### Technical Field

The present disclosure relates to a surface-modified composite solid electrolyte used in an all-solid-state battery and a method for preparing the same.

### TECHNICAL FIELD

Lithium-ion batteries are the most commonly applied energy systems in electric vehicles due to their high energy density and long lifespan. However, since the lithium ion battery uses a flammable organic liquid electrolyte, the electrolyte may volatilize at a high temperature and cause ignition or large explosion. Thus, the safety problem of the electric vehicle using the lithium ion battery as an energy power is still a problem to be solved.

In order to solve such a problem of stability of the lithium ion battery, an all-solid-state battery including a solid electrolyte having higher safety than an organic liquid electrolyte is attracting attention as a promising next-generation secondary battery to replace the lithium ion battery.

Various types of solid electrolytes have been studied to improve the electrochemical performance of all-solid state batteries, such as polymer electrolytes, oxide-based, halogen-based, sulfide-based solid electrolytes, and the like. Among them, the sulfide-based solid electrolyte has advantages of high lithium ionic conductivity and excellent flexibility.

However, the sulfide-based solid electrolyte has a limitation in advancing to the practical stage due to unstable interface stability. Specifically, the electrochemical stable window of the sulfide-based solid electrolyte is very narrow compared to the operating voltage of the transition metal oxide-based positive electrode active material having a layered structure, and has high reactivity with moisture and the oxide-based positive electrode active material, so that phosphate and sulfur oxides may be formed on the surface of the electrolyte, and may be electrochemically oxidized during the charging process to form P₂Sₓ (x>5) or a plurality of sulfide bonds (—S—S—) at the interface between the positive electrode and the solid electrolyte.

In this way, the product formed by chemically and electrochemically decomposing the sulfide-based solid electrolyte has very poor ionic conductivity, and thus, interface resistance between the sulfide-based solid electrolyte and the positive electrode may be very large. Accordingly, it is necessary to coat the surface of the positive electrode active material with a protective film in order to improve the interface stability of the sulfide-based solid electrolyte. Meanwhile, recently, a study has been published that a large number of side reactions occur at the interface between the sulfide-based solid electrolyte and the conductive material, and in the end, surface treatment is required on the positive electrode active material and the conductive material to form a stable interface, and thus there is a disadvantage in that the process cost according to the surface treatment may be increased when the sulfide-based solid electrolyte is used.

Accordingly, methods of modifying the surface of the sulfide-based solid electrolyte have been proposed in order to develop an electrochemically stable sulfide-based solid electrolyte. However, there is no stable solid electrolyte that satisfies the requirements for commercialization of the all-solid-state battery so far.

Therefore, there is a need to develop a solid electrolyte that suppresses an interface side reaction of a sulfide-based solid electrolyte with a positive electrode active material and improves the performance and stability of an all-solid-state battery.

### DISCLOSURE

### Technical Problem

In order to solve the above-described problems, the present disclosure provides a surface-modified composite solid electrolyte which is chemically and electrochemically stable at the interface thereof with a positive electrode active material or a conductive material by forming a coating film containing a functional group derived from a chalcogen-based compound on a surface of a sulfide-based solid electrolyte particle.

### Technical Solution

According to an embodiment of the present disclosure, there is provided a surface-modified composite solid electrolyte comprising: a sulfide-based solid electrolyte particle; and a coating film formed on a surface of the sulfide-based solid electrolyte particle, wherein the coating film contains a functional group derived from a chalcogen-based compound, wherein the chalcogen-based compound is represented by a following Chemical Formula 1:

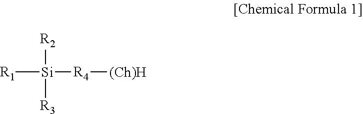

wherein in the Chemical Formula 1,
each of R₁ to R₃ independently represents a hydrogen atom or a monovalent linear or branched alkyl group having C₁ to C₁₀ carbon atoms, R₄ represents a divalent linear or branched alkylene group having C₁ to C₁₀ carbon atoms, Ch represents a chalcogen element.

Further, according to an embodiment of the present disclosure, there is provided a method for preparing a surface-modified composite solid electrolyte, the method comprising: removing a solvent from a mixed solution including a chalcogen-based compound represented by the above Chemical Formula 1, the solvent, and sulfide-based solid electrolyte particles; and drying a resultant product after removing the solvent.

### Advantageous Effects

According to the surface-modified composite solid electrolyte of the present disclosure and the preparation method thereof, the coating film containing the functional group derived from the chalcogen-based compound having excellent chemical stability is applied to the surface of the sulfide-based solid electrolyte, thereby suppressing side reactions at the interface thereof with a positive electrode active material or a conductive material through a simple process. As a result, there is an effect of providing a solid electrolyte capable of improving the chemical and electrochemical stability of the all-solid-state battery.

### DESCRIPTION OF DRAWINGS

FIG. 1a is a diagram showing results of Raman spectroscopy analysis and infrared spectroscopy analysis on the surface-modified composite solid electrolyte according to Example 1.

FIG. 1b is a diagram showing results of Raman spectroscopy analysis and infrared spectroscopy analysis on the surface-modified composite solid electrolyte according to Example 2.

FIG. 1c is a diagram showing results of Raman spectroscopy analysis and infrared spectroscopy analysis on the surface-modified composite solid electrolyte according to Comparative Example 1.

FIG. 1d is a diagram showing results of Raman spectroscopy analysis and infrared spectroscopy analysis on the surface-modified composite solid electrolyte according to Comparative Example 2.

FIG. 2a is a diagram showing the results of SEM image and energy dispersive X-ray spectroscopy (EDS) analysis on Bare-LPSCI.

FIG. 2b is a diagram showing the results of SEM image and energy dispersive X-ray spectroscopy (EDS) analysis on the surface modified composite solid electrolyte according to Example 1.

FIG. 2c is a diagram showing the results of SEM image and energy dispersive X-ray spectroscopy (EDS) analysis on the surface modified composite solid electrolyte according to Example 2.

FIG. 2d is a diagram showing the results of SEM image and energy dispersive X-ray spectroscopy (EDS) analysis on the surface modified composite solid electrolyte according to Comparative Example 1.

FIG. 2e is a diagram showing the results of TEM image and energy dispersive X-ray spectroscopy (EDS) analysis on the surface modified composite solid electrolyte according to Example 1.

FIG. 2f is a diagram showing the results of TEM image and energy dispersive X-ray spectroscopy (EDS) analysis on the surface modified composite solid electrolyte according to Example 2.

FIG. 3 is a diagram showing results of measuring ionic conductivity of the surface-modified composite solid electrolyte according to Example 1 and Bare-LPSCI.

FIG. 4a is a diagram showing a change in specific capacity according to the cycle progress of the all-solid-state batteries according to Example 3 and Comparative Example 3 under charging at 0.1 C-rate and discharging conditions at 1 C-rate.

FIG. 4b is a diagram showing a change in specific capacity according to the cycle progress of all-solid-state batteries according to Example 3, Comparative Example 3, and Comparative Example 4 under a charging and discharging condition of 0.1 C-rate.

FIG. 5 is a diagram showing the all-solid-state batteries according to Example 3, Comparative Example 3, and Comparative Example 4 measured capacities according to a charge/discharge rate (C-rate).

FIG. 6a is a diagram showing a change in specific capacity according to the cycle progress of all-solid-state batteries according to Examples 3 and 4 under charging at 0.2 C-rate and discharging conditions at 0.5 C-rate.

FIG. 6b is a diagram showing results of measuring ionic conductivities according to Example 5 and Example 6, and Bare-LPSCI.

FIG. 7 is a diagram showing the results of measuring the ionic conductivity of an all-solid-state battery in which a content of the chalcogen-based compound varies.

### MODE FOR INVENTION

Hereinafter, a surface-modified composite solid electrolyte and a method for preparing the same according to the present disclosure will be described in detail with reference to the accompanying drawings so that those skilled in the art to which the present disclosure pertains may easily implement the same.

According to an embodiment of the present disclosure, the surface-modified composite solid electrolyte comprises a sulfide-based solid electrolyte particle; and a coating film formed on a surface of the sulfide-based solid electrolyte particle, wherein the coating film contains a functional group derived from a chalcogen-based compound, wherein the chalcogen-based compound is represented by a following Chemical Formula 1:

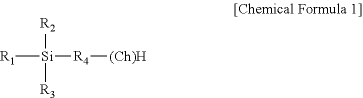

wherein in the Chemical Formula 1,
each of R₁ to R₃ independently represents a hydrogen atom or a monovalent linear or branched alkyl group having C₁ to C₁₀ carbon atoms, R₄ represents a divalent linear or branched alkylene group having C₁ to C₁₀ carbon atoms, Ch represents a chalcogen element.

The chalcogen element may include at least one selected from the group consisting of oxygen (O), sulfur(S), selenium (Se), tellurium (Te), polonium (Po), and livermorium (Lv).

Preferably, in the Chemical Formula 1, each of R₁ to R₃ may be hydrogen or a monovalent linear or branched alkyl group having C₁ to C₅ carbon atoms, R₄ may be a divalent linear or branched alkyl group having C₁ to C₅ carbon atoms, Ch may be O or S. More preferably, in the Chemical Formula 1, each of R₁ to R₃ may be hydrogen or a monovalent linear or branched alkyl group having C₁ to C₃ carbon atoms, R₄ may be a divalent linear or branched alkyl group having C₁ to C₃ carbon atoms, and Ch may be S.

The sulfide-based solid electrolyte particle is a kind of inorganic-based solid electrolyte particle, and may refer to a particle containing sulfur(S), having ionic conductivity of a metal belonging to Group 1 or Group 2 of the periodic table, and having electron insulation. Preferably, the sulfide-based solid electrolyte particle contains at least Li, S, and P as elements and may have lithium ionic conductivity.

Due to unique ductility, the sulfide-based solid electrolyte particle may be subjected only to cold-pressing to obtain an interface contact between an electrode and a solid electrolyte at a level usable in an all-solid-state battery. In addition, since the sulfur ion has a larger size and better polarization than the oxygen ion, the sulfide-based solid electrolyte particle generally have higher ionic conductivity than the oxide-based solid electrolyte particle, and thus may be suitable as a solid electrolyte for a bulk-type lithium all-solid-state battery.

The sulfide-based solid electrolyte particle may be represented by a following Chemical Formula 2.

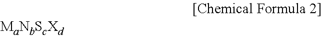

wherein in the Chemical Formula 2, M is at least one selected from Li and Na, N is at least one selected from the group consisting of P, B, Al, Ga, In, Si, Ge, Sn, Pb, Sb, Bi, Ti, V, Cr, Mn, Fe, Co, Ni, Cu, Y, Zr, Nb, Mo, Tc, Ru, Rh, Pd, Ag, Hf, Ta and W, X is at least one selected from the group consisting of Cl, F, Br, I, O, Se, and Te, 0≤a≤8, 0≤b≤6, 0≤c≤11, and 0≤d≤6.

Specifically, the sulfide-based solid electrolyte particle may include at least one selected from the group consisting of Li₆PS₅Cl, Li₃PS₄, Li₇P₃S₁₁, Li₆PS₅F, Li₆PS₅Br, Li₆PS₅I and Li₇P₂S₈I, preferably, Li₆PS₅Cl.

The coating film containing the functional group derived from the chalcogen-based compound may be distributed at a uniform thickness on the surface of the sulfide-based solid electrolyte particle. This is due to the adsorption of the chalcogen-based compound to the surface of the sulfide-based solid electrolyte via hydrogen bond between the -(Ch)H functional group of the chalcogen-based compound and the sulfide-based solid electrolyte and the chalcogen-chalcogen interaction.

Specifically, the coating film containing the functional group derived from the chalcogen-based compound may have an average thickness of 1 to 10 nm, preferably 5 to 8 nm, more preferably 5.5 to 6.5 nm. When the average thickness of the coating film containing the functional group derived from the chalcogen-based compound satisfies the above numerical range, a decrease in ionic conductivity of the sulfide-based solid electrolyte on which the coating film is formed may be minimized. On the other hand, when the average thickness of the coating film containing the functional group derived from the chalcogen-based compound exceeds the above numerical range, ionic conductivity may decrease and thus the sulfide-based solid electrolyte may not be suitable for use as a solid electrolyte.

The chalcogen-based compound may be contained in a content of 2 to 8 parts by weight, preferably 3 to 7 parts by weight, and more preferably 4 to 6 parts by weight, based on 100 parts by weight of the sulfide-based solid electrolyte particle. Since the chalcogen-based compound is contained in a content within the above numerical range with respect to 100 parts by weight of the sulfide-based solid electrolyte particle, the chalcogen-based compound may be adsorbed to the sulfide-based solid electrolyte particle to the maximum, and accordingly, the electrochemical stability of the surface-modified composite solid electrolyte may be improved.

In the surface-modified composite solid electrolyte, a coating film containing a functional group derived from a chalcogen-based compound, preferably a coating film containing a thiol group or a hydroxyl group, and more preferably a coating film containing a functional group containing a thiol group are formed on the surface of the sulfide-based solid electrolyte particle to prevent contact between oxygen and the sulfide-based solid electrolyte particle, such that the ionic conductivity of the surface-modified composite solid electrolyte may not be significantly reduced even when the surface-modified composite solid electrolyte is stored in an oxygen atmosphere for a long time. Specifically, after the surface-modified composite solid electrolyte has been stored in an oxygen atmosphere for at least 2 days, 70% or greater, preferably 75% or greater, and more preferably 80% or greater of an initial ionic conductivity thereof may be maintained.

According to another embodiment of the present disclosure, there is provided an all-solid-state battery including: a composite positive electrode including a positive electrode active material and a conductive material; and the surface-modified composite solid electrolyte.

The positive electrode active material may be represented by the following Chemical Formula 3.

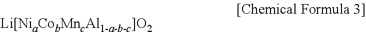

wherein in the Chemical Formula 3,
0≤a≤1, 0≤b≤1, and 0≤c≤1.

Specifically, the positive electrode active material may include at least one selected from the group consisting of LiCoO₂, LiNiO₂, LiNi_{0.3}Mn_{0.3}Co_{0.3}O₂, LiNi_{0.3}Co_{0.3}Al_{0.3}O₂, and LiNi_{0.25}Co_{0.25}Mn_{0.25}Al_{0.25}O₂. However, the positive electrode active material is not necessarily limited thereto, and any material capable of reversibly intercalating and releasing lithium ions may be applied.

The conductive material may include at least one selected from the group consisting of natural graphite, artificial graphite, graphite, carbon black, acetylene black, Ketjen black, channel black, furnace black, lamp black, thermal black, carbon fiber, metal fiber, fluorinated carbon, aluminum, nickel powder, zinc oxide, potassium titanate, and titanium oxide.

The composite positive electrode may further include a positive electrode current collector. The positive electrode current collector may be made of stainless steel, aluminum, nickel, titanium, calcined carbon, or aluminum or stainless steel surface treated with carbon, nickel, titanium, silver, or the like. The material of the positive electrode current collector is not particularly limited as long as it has conductivity without causing a chemical change in the present battery.

In addition, the all-solid-state battery may further include a negative electrode, and the negative electrode may include a negative electrode active material and a negative electrode current collector.

As the negative electrode active material, lithium metal, a carbon material, silicon, silicon, tin, or the like capable of intercalating and releasing lithium ions may be used, and preferably, lithium metal may be used.

The negative electrode current collector may be formed in the form of a foil or a plate. In general, the negative electrode current collector may be at least one selected from the group consisting of copper, stainless steel, aluminum, nickel, titanium, fired carbon, copper or stainless steel surface-treated with carbon, nickel, titanium, silver, and the like, and aluminum-cadmium alloy, but is not necessarily limited thereto. Any material having conductivity without causing chemical changes in the battery may be used without limitation.

The capacity of the all-solid-state battery after 2000 cycles may be maintained at 80% or greater, preferably at 82% or greater, more preferably at 85% or greater of an initial capacity. The all-solid-state battery has coulombic efficiency maintained at 99% or greater for 2000 cycles.

In addition, a reversible capacity of the all-solid-state battery at a discharge rate of 4 C-rate under a charge rate of 0.1 C-rate is at least 60%, preferably 65% or greater, and more preferably 70% or greater of a reversible capacity thereof at a discharge rate of 0.1 C-rate under the charge rate of 0.1 C-rate.

The performance of the all-solid-state battery may be improved as follows: The coating film containing a functional group derived from a chalcogen-based compound is formed on the sulfide-based solid electrolyte, such that a positive electrode electrolyte interface (CEI) layer is formed while the chalcogen-based compound is decomposed, thereby preventing the interface between the sulfide-based solid electrolyte and the positive electrode active material from being electrochemically decomposed.

According to still another embodiment of the present disclosure, there is provided a method for preparing a surface-modified composite solid electrolyte, the method including: removing a solvent from a mixed solution including the chalcogen-based compound represented by the following Chemical Formula 1, the solvent, and the sulfide-based solid electrolyte particle; and drying a resultant product after the solvent has been removed.

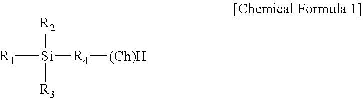

wherein in the Chemical Formula 1,
each of R₁ to R₃ independently represents a hydrogen atom or a monovalent linear or branched alkyl group having C₁ to C₁₀ carbon atoms, R₄ represents a divalent linear or branched alkylene group having C₁ to C₁₀ carbon atoms, Ch represents a chalcogen element.

The chalcogen element may include at least one selected from the group consisting of oxygen (O), sulfur(S), selenium (Se), tellurium (Te), polonium (Po), and livermorium (Lv).

Preferably, in the Chemical Formula 1, each of R₁ to R₃ may be hydrogen or a monovalent linear or branched alkyl group having C₁ to C₅ carbon atoms, R₄ may be a divalent linear or branched alkyl group having C₁ to C₅ carbon atoms, Ch may be O or S. More preferably, in the Chemical Formula 1, each of R₁ to R₃ may be hydrogen or a monovalent linear or branched alkyl group having C₁ to C₃ carbon atoms, R₄ may be a divalent linear or branched alkyl group having C₁ to C₃ carbon atoms, and Ch may be S.

The sulfide-based solid electrolyte particle may be represented by the following Chemical Formula 2.

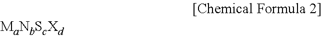

wherein in the Chemical Formula 2, M is at least one selected from Li and Na, N is at least one selected from the group consisting of P, B, Al, Ga, In, Si, Ge, Sn, Pb, Sb, Bi, Ti, V, Cr, Mn, Fe, Co, Ni, Cu, Y, Zr, Nb, Mo, Tc, Ru, Rh, Pd, Ag, Hf, Ta and W, X is at least one selected from the group consisting of Cl, F, Br, I, O, Se, and Te, 0≤a≤8, 0≤b≤6, 0≤c≤11, and 0≤d≤6.

Specifically, the sulfide-based solid electrolyte particle may include at least one selected from the group consisting of Li₆PS₅Cl, Li₃PS₄, Li₇P₃S₁₁, Li₆PS₅F, Li₆PS₅Br, Li₆PS₅I and Li₇P₂S₈I.

The solvent may include at least one selected from the group consisting of tetrahydrofuran (THF), N-methyl-2-pyrrolidone (NMP), acetone, ethanol, dimethyl acetamide (DMAc) and toluene.

First, the chalcogen-based compound represented by the Chemical Formula 1 and the solvent are mixed with each other, and the sulfide-based solid electrolyte particle are added to the mixed solution. In this regard, the chalcogen-based compound represented by the Chemical Formula 1 may be mixed in a content of 8 to 12 parts by weight, preferably 9 to 11 parts by weight, more preferably 9.5 to 10.5 parts by weight, based on 100 parts by weight of the sulfide-based solid electrolyte particles.

Thereafter, the mixed solution may be stirred at 500 to 700 rpm for 2 to 4 hours to adsorb the chalcogen-based compound onto the surface of the sulfide-based solid electrolyte particles.

Then, centrifugation may be performed to remove the non-adsorbed chalcogen-based compound and the solvent, and a step of drying the resultant after the solvent removal may be performed.

The drying may be performed for 10 to 14 hours under a vacuum at 30 to 50° C.

Hereinafter, the present disclosure will be described in more detail through Examples. However, these Examples are only intended to help the understanding of the present disclosure, and the scope of the present disclosure is not limited to these Examples in any sense.

### <Example 1> Preparation of Surface-Modified Composite Solid Electrolyte 1

First, 2-(trimethylsilyl) ethanethiol (TMS-SH, Aldrich, 95%) of 0.05 g is dissolved in 3 mL of tetrahydrofuran (THF, Alfa, 99.8%) solvent to prepare a solution of 0.1M.

Then, 0.5 g of Li₆PS₅Cl (LPSCI) powders are added to the solution, followed by mixing at 600 rpm for 3 hours to allow 2-(trimethylsilyl) ethanethiol to be adsorbed on the LPSCI surface.

The solution is centrifuged at 8000 rpm for 20 minutes to remove the THF solvent containing unreacted 2-(trimethylsilyl) ethanethiol. Thereafter, the drying is performed thereon at 40° C. under vacuum condition for 12 hours to obtain a LPSCI solid electrolyte on which a 2-(trimethylsilyl) ethanethiol coating film is formed.

### <Example 2> Preparation of Surface-Modified Composite Solid Electrolyte 2

A surface-modified composite solid electrolyte was prepared in the same manner as in Example 1, except that 2-(trimethylsilyl) ethanol (TMS-OH, Aldrich, 96%) was applied instead of 2-(trimethylsilyl) ethanethiol.

### <Comparative Example 1> Preparation of Surface-Modified Composite Solid Electrolyte 3

A surface-modified composite solid electrolyte was prepared in the same manner as in Example 1, except that bis(trimethylsilyl) methane (Bis-TMS, Aldrich, 97%) was applied instead of 2-(trimethylsilyl) ethanethiol.

### <Comparative Example 2> Preparation of Surface-Modified Composite Solid Electrolyte 4

A surface-modified composite solid electrolyte was prepared in the same manner as in Example 1, except that 1-dodecanethiol (DDT-SH, Aldrich, 98%) was applied instead of 2-(trimethylsilyl) ethanethiol.

### <Example 3> Manufacturing of All-Solid-State Battery 1

A bulk type all-solid-state battery composed of three layers, that is, the positive electrode pellets, the electrolyte pellets, and the lithium metal foil was manufactured.

The electrolyte pellets were prepared by pressing LPSCI (bare LPSCI) to which no material was adsorbed, at 145 MPa.

The positive electrode pellets were prepared by mixing the surface-modified composite solid electrolyte according to Example 1 with LiCoO₂ and a carbon additive (Super P), wherein LiCoO₂: the surface-modified composite solid electrolyte according to Example 1: Super P were mixed each other at a weight ratio=12:7:1. The mixed powders were placed on the electrolyte pellets and applied thereto under a pressure of 360 MPa. The loading amount of LiCoO₂ was 6.8 mg/cm².

The lithium metal foil was attached to an opposite side of the electrolyte pellet to a side thereof on which the positive electrode pellet was located.

### <Example 4> Manufacturing of All-Solid-State Battery 2

An all-solid-state battery was manufactured in the same manner as in Example 3, except that the surface-modified composite solid electrolyte according to Example 2 was used instead of the surface-modified composite solid electrolyte according to Example 1 in the preparation of the positive electrode pellets.

### <Comparative Example 3> Manufacturing of All-Solid-State Battery 3

An all-solid-state battery was manufactured in the same manner as in Example 3, except that LPSCI powder (bare LPSCI) without adsorbed material thereto was used instead of the surface-modified composite solid electrolyte according to Example 1 in the preparation of the positive electrode pellet.

### <Comparative Example 4> Manufacturing of All-Solid-State Battery 4

An all-solid-state battery was manufactured in the same manner as in Example 3, except that the composite solid electrolyte according to Comparative Example 2 was used instead of the surface-modified composite solid electrolyte according to Example 1 during the preparation of the positive electrode pellet.

### <Example 5> Preparation of Solid Electrolyte Pellet 1

A bulk type solid electrolyte pellet in which the surface-modified composite solid electrolyte according to Example 1 constituted a single layer was prepared.

In this regard, the electrolyte pellet was prepared by pressing the surface-modified composite solid electrolyte according to Example 1 at 360 MPa.

### <Example 6> Manufacturing of All-Solid-State Battery Including Solid Electrolyte Pellets 2

A solid electrolyte pellet was prepared in the same manner as in Example 5, except that the surface-modified composite solid electrolyte according to Example 2 was used instead of the surface-modified composite solid electrolyte according to Example 1 in the preparation of the solid electrolyte pellet.

### <Experimental Example 1> Structural Analysis of Surface-Modified Composite Solid Electrolyte

In order to analyze the structure of the surface-modified composite solid electrolyte, Raman spectroscopy and infrared spectroscopy were used on the surface-modified composite solid electrolyte according to Example 1, Example 2, Comparative Example 1 and Comparative Example 2.

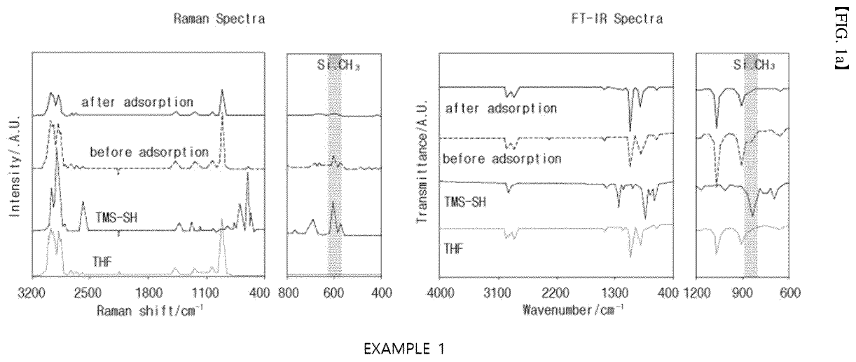

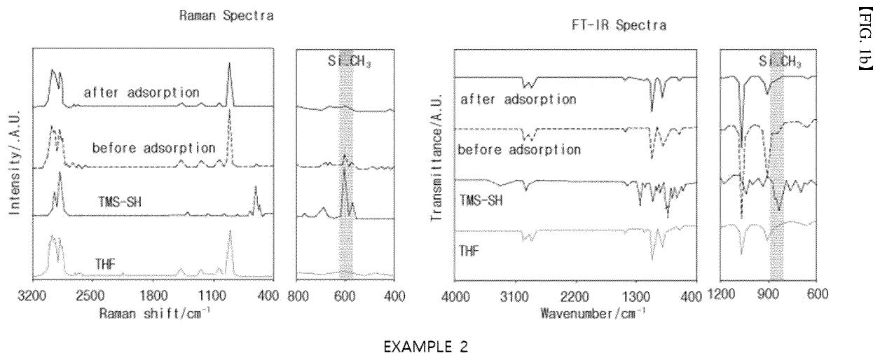

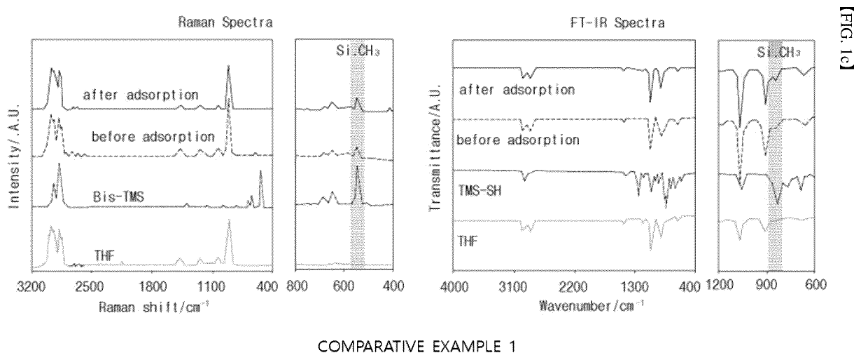

In particular, in order to more clearly identify how much the chalcogen-based compound is adsorbed onto the surface of the sulfide-based solid electrolyte (LPSCI), the THF solvent itself, the compound (TMS-SH, TMS-OH, Bis-TMS, and DDT-SH) applied to form the coating film on the surface of the sulfide-based solid electrolyte, and the solvents before and after the adsorption of the compound were compared with each other. The comparing results are shown in FIGS. 1a to 1d.

First, the results of the surface-modified composite solid electrolytes of Example 1, Example 2, and Comparative Example 1 were analyzed to examine the effect of the functional groups on the adsorption of the chalcogen-based compound to LPSCI.

All of the compounds applied to form the coating film via adsorption thereof to the sulfide-based solid electrolyte in Example 1, Example 2, and Comparative Example 1 have a trimethylsilyl group (Si—CH₃) in common. The 2-(trimethylsilyl) ethanethiol (TMS-SH) applied in Example 1 has a thiol group, the 2-(trimethylsilyl) ethanol (TMS-OH) applied in Example 2 has a hydroxy group, and the 2-(trimethylsilyl) methane (Bis-TMS) applied in Comparative Example 1 does not contain a separate functional group other than the silyl group.

Referring to FIGS. 1A to 1C, the before-adsorption mixture solution may exhibit strong peaks at 600 cm⁻¹ (Raman spectrum) and 820 cm⁻¹ (IR spectrum) in all cases, which is due to Si—CH₃.

In the case of Examples 1 and 2, it may be identified that the intensity of the peak decreases, based on the comparison between the after-adsorption mixture solution and before-adsorption mixture solution. This means that the concentrations of TMS-SH and TMS-OH in the solvent decrease because significant amounts of TMS-SH and TMS-OH adsorb to the LPSCI surface. On the other hand, in the case of Comparative Example 1, the decrease in the peak is hardly changed before and after the adsorption (that is, before and after the addition of LPSCI), which means that Bis-TMS is hardly adsorbed on the LPSCI surface.

Through this result, it may be identified that TMS-SH or TMS-OH can bind to the LPSCI surface via hydrogen bond between the LPSCI surface and the thiol group or the hydroxy group and chalcogen-chalcogen interaction.

Next, in order to examine the effect of the trimethylsilyl group (—Si(CH₃)₃) on the adsorption of the chalcogen-based compound to LPSCI, the results of the surface-modified composite solid electrolytes according to Example 1 and Comparative Example 2 were compared with each other.

The 2-(trimethylsilyl) ethanethiol (TMS-SH) applied in Example 1 contained both a thiol group and a trimethylsilyl group, and the 1-dodecanethiol (DDT-SH) applied in Comparative Example 2 contained only a thiol group without a trimethylsilyl group.

Referring to FIG. 1A, in Comparative Example 2, before the adsorption, a strong peak was exhibited at about 2580 cm⁻¹ (—SH) of the Raman spectrum and 2930 cm⁻¹ (—CH₂) of the IR spectrum, while after adsorption, the intensity of the peaks was significantly reduced, which means that a significant amount of DDT-SH was adsorbed on the LPSCI surface.

### <Experimental Example 2> Observation of Structure of Surface-Modified Composite Solid Electrolyte

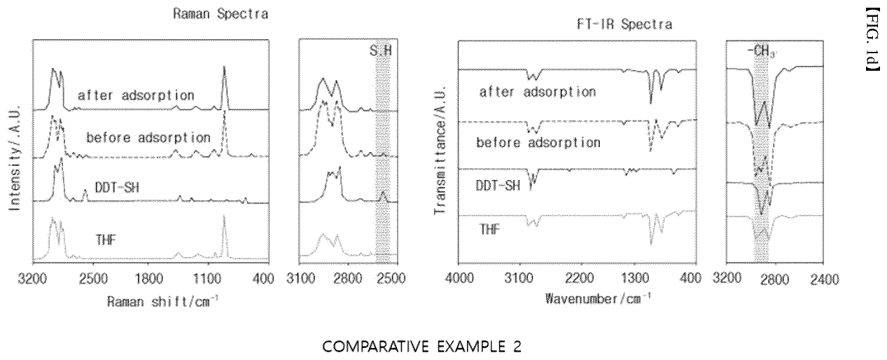

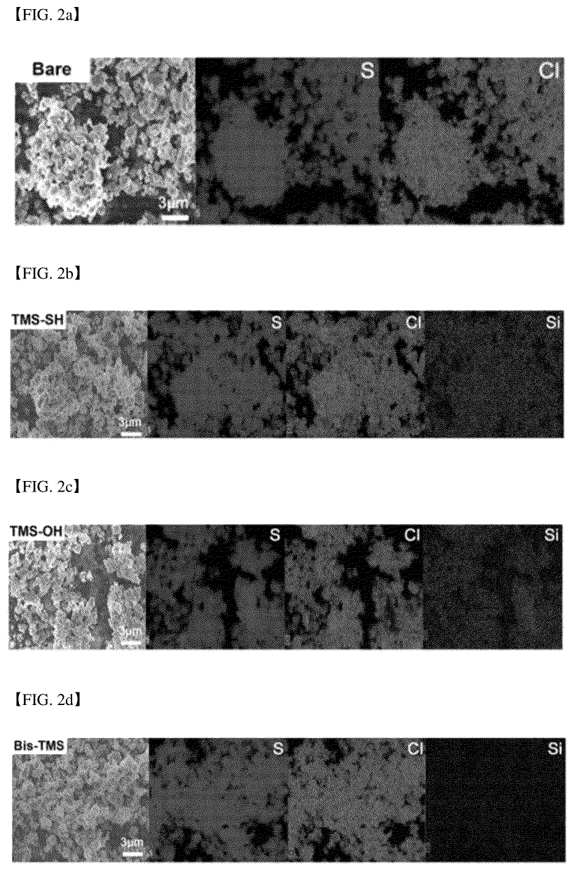

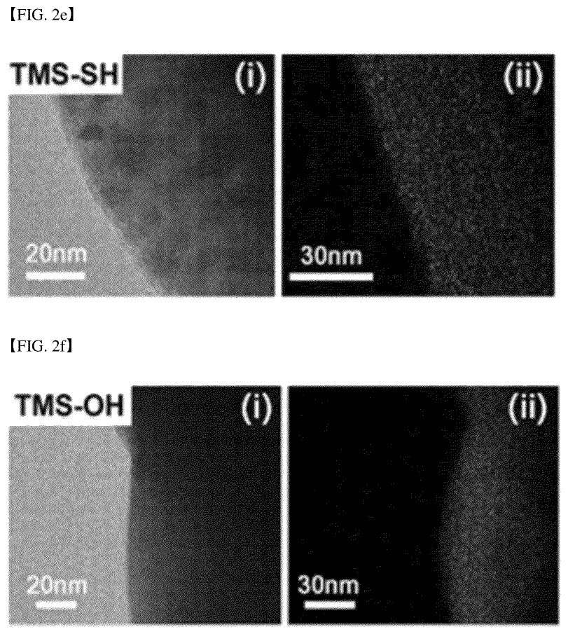

To observe the structure of the surface-modified composite solid electrolyte, images of LPSCI itself as the sulfide-based solid electrolyte, and LPSCI in the surface-modified composite solid electrolyte according to each of Example 1, Example 2, and Comparative Example 1 were photographed using SEM and energy-dispersive X-ray spectroscopy (EDS), and are shown in FIGS. 2a to 2d.

In the case of Examples 1 and 2, the Si component was uniformly applied to the LPSCI surface (see FIGS. 2b and 2c), whereas in the case of Comparative Example 1, only a small amount of Bis-TMS was applied to the LPSCI surface (see FIG. 2d).

This means that TMS-SH or TMS-OH may bind to the LPSCI surface via hydrogen bond between the LPSCI surface and a thiol group or a hydroxyl group and chalcogen-chalcogen interaction as in Experimental Example 1.

FIGS. 2e and 2f show TEM and EDS images of the surface-modified composite solid electrolytes according to Example 1 and Example 2, respectively. The thickness of each of the TMS-SH and TMS-OH layers was about 6 nm.

Although not shown separately in the drawings, in the case of Comparative Example 2 in which 1-dodecanethiol was applied, no conspicuous structure was observed on the TEM and EDS images because there was no element which can be specified such as Si.

### <Experimental Example 3> Evaluation of Stability of Surface-Modified Composite Solid Electrolyte in Air

In the preparing process of the all-solid-state battery, stability of the sulfide-based solid electrolyte with respect to oxygen is an important factor that determines the electrochemical performance of the all-solid-state battery. Thus, in order to evaluate the chemical stability of the surface-modified composite solid electrolyte according to Example 1 in an air atmosphere, the surface-modified composite solid electrolyte according to Example 1 was contained in a container equipped with an inlet tube and an outlet tube, and moisture-removed oxygen was supplied to the container at a speed of 100 mL/min for 6 days.

Thereafter, the ionic conductivity of the electrolyte was measured and shown in FIG. 3.

Meanwhile, in order to be compared with Example 1, an experiment was performed on LPSCI (Bare-LPSCI) to which no material was adsorbed under the same conditions, and the results are shown in FIG. 3.

FIG. 3 shows a change in ionic conductivity over time, wherein in the case of Bare-LPSCI, the ionic conductivity rapidly decreases from 1.23 mS/cm to 0.4 mS/cm after 6 days, whereas in the case of the surface-modified composite solid electrolyte according to Example 1, there was little change in ionic conductivity even after 6 days of exposure to oxygen. This is because the TMS-SH layer adsorbed to LPSCI minimizes the oxidation of LPSCI under an oxygen atmosphere, thereby improving the chemical stability of LPSCI. That is, TMS-SH may be a very promising additive in actual application to the battery preparing industry.

### <Experimental Example 4> Performance Evaluation of All-Solid-State Battery 1

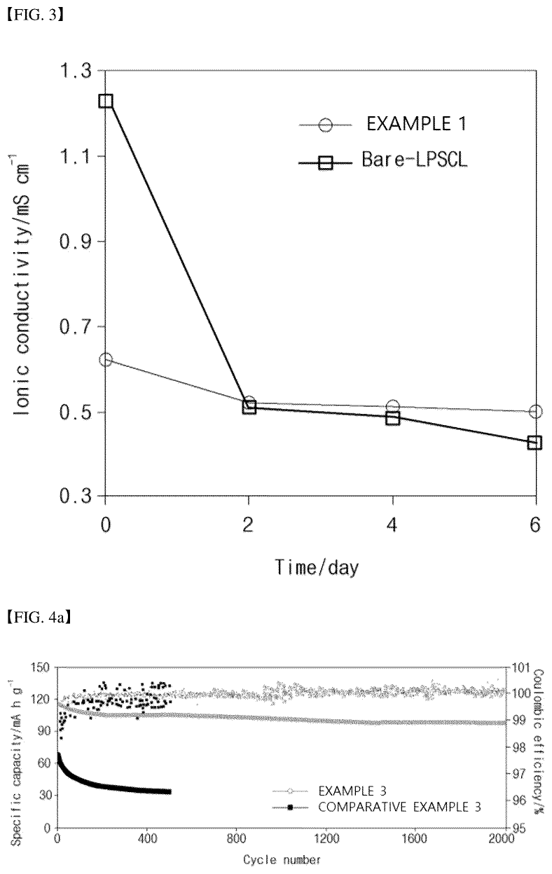

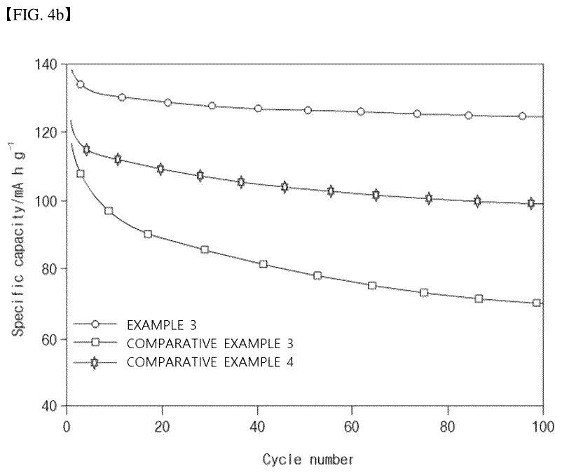

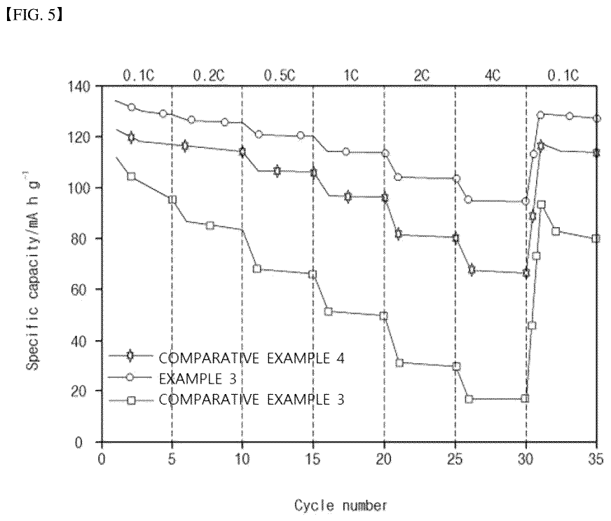

In order to evaluate the performance of the all-solid-state battery to which the surface-modified composite solid electrolyte according to Example 1 was applied, a change in specific capacity according to the cycle progress of the all-solid-state batteries according to Example 3, Comparative Example 3, and Comparative Example 4 was observed. FIG. 4a shows the results of the discharge test under the same voltage range (2.5 to 4.3V (vs.Li/Li+)), 0.1 C-rate charge, 1 C-rate discharge, and 30° C. conditions after 3 cycles at 2.5 to 4.3V (vs.Li/Li+) voltage range and 0.1 C-rate. FIG. 4b shows the results of the charge/discharge test under the 2.5 to 4.3V (vs. Li/Li+) voltage range, 0.1 C-rate, and 30° C. conditions.

First, the performances of the all-solid-state batteries according to Example 3 and Comparative Example 3 were compared with each other and the comparing result is shown in FIG. 4a. In the case of the all-solid-state battery according to Example 3, the capacity was maintained as much as 85% of the initial capacity even after 2000 cycles, thus exhibiting excellent life characteristics.

On the other hand, the all-solid-state battery according to Comparative Example 3 exhibited a capacity retention rate of 49.7% after 500 cycles, thus exhibiting poor life characteristics compared to Example 3.

Referring to FIG. 4b, Example 3 exhibited the high reversible capacity and a more stable capacity retention rate compared to Comparative Example 3 and Comparative Example 4 during 100 cycles. This means that the interface layer formed from the surface-modified composite solid electrolyte contained in the all-solid-state battery of Example 3 is stably maintained even at a high battery capacity level such as 4.3V.

Specifically, based on the fact that the capacity retention rate of the all-solid-state battery according to Comparative Example 4 is superior to the capacity retention rate of the all-solid-state battery according to Comparative Example 3, it may be identified that a more stable thin film layer was formed under the presence of a thiol group having a hydrogen bond with the LPSCI electrolyte and a chalcogen-chalcogen interaction. In addition, based on the fact that the capacity retention rate of the all-solid-state battery according to Example 3 is superior to that of the all-solid-state battery according to Comparative Example 4, it may be identified that the trimethylsilyl group played an important role in forming a more stable thin film layer on the LPSCI surface.

### <Experimental Example 4> Performance Evaluation of All-Solid-State Battery 2

In order to identify the performance of the all-solid-state battery according to the type of the surface-modified composite solid electrolyte, the capacity according to the charge/discharge rate (C-rate) was measured on the all-solid-state batteries according to Example 2 and Comparative Example 3, and the result is shown in FIG. 5.

The all-solid-state battery according to Example 2 exhibited excellent discharge rate characteristics compared to Comparative Example 3.

Specifically, at 4 C-rate, the all-solid-state battery according to Example 2 exhibited a capacity of 100 mA·h/g, whereas the all-solid-state battery according to Comparative Example 3 exhibited a capacity of 17 mA·h/g, and the all-solid-state battery according to Comparative Example 4 exhibited a capacity of 67 mA·h/g.

### <Experimental Example 5> Performance Evaluation of All-Solid-State Battery 3

In order to compare the effects of the solid electrolytes according to Examples 1 and 2 showing excellent performance among the surface-modified composite solid electrolytes with each other, charge/discharge tests were performed for 100 cycles on the all-solid-state batteries according to Examples 3 and 4, and a change in specific capacity was observed. The charging and discharging were performed at 0.2 C-rate during charging and 0.5 C-rate during discharging.

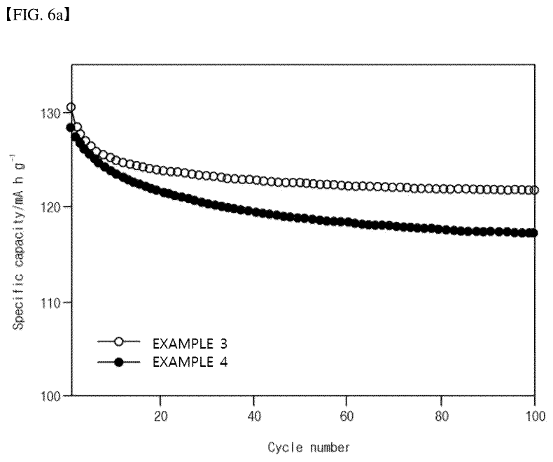

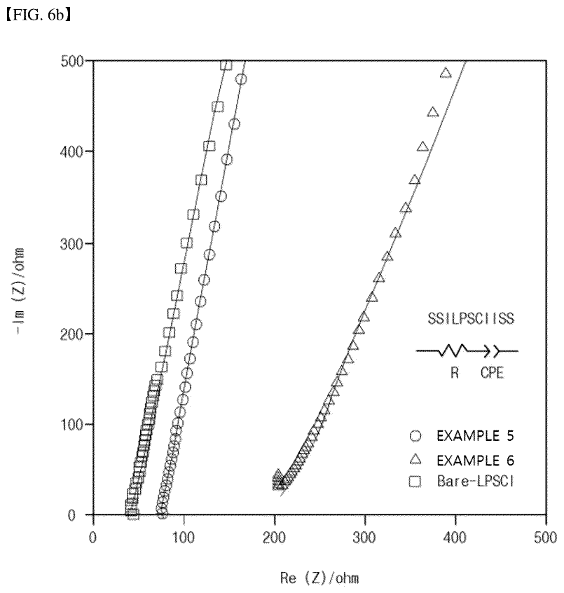

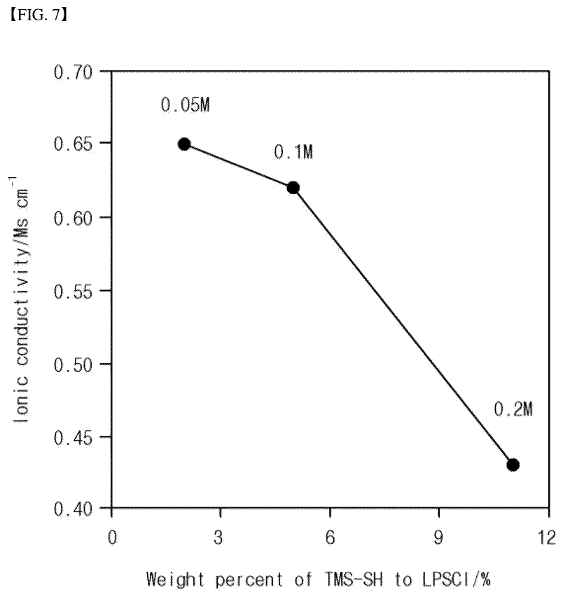

Referring to FIG. 6a, after 100 cycles, it may be identified that the all-solid-state battery according to Example 3 has a higher capacity than the all-solid-state battery according to Example 4. This means that the thin film layer formed on the surface-modified composite solid electrolyte applied to Example 3 is more stably formed than the thin film layer formed on the surface-modified composite solid electrolyte applied to Example 4.

Referring to FIG. 6b, Example 5 and Example 6 exhibit a lower ionic conductivity than that of Bare-LPSCI (LPSCI) onto which no material is adsorbed. In this regard, considering that it is a general phenomenon that ionic conductivity decreases when a material is adsorbed to Bare-LPSCI, it may be identified that such a decrease in ionic conductivity may be minimized in the case of Example 5 including a thiol group.

Further, it was identified that the ionic conductivity of the electrolyte according to Example 5 had a higher value than the ionic conductivity of the electrolyte according to Example 6. This specifically means that the hydroxy group (—OH) oxidizes the LPSCI surface, resulting in a significant decrease in ionic conductivity, thereby causing a difference in performance. This means that in order to achieve the higher ionic conductivity, the interaction between LPSCI and the thiol group (—SH) is more desirable in forming the solid electrolyte than the interaction between LPSCI and the hydroxyl group (—OH).

### <Experimental Example 6> Evaluation of Ionic Conductivity Based on Content of Chalcogen-Based Compound (TMS-SH)

In order to analyze the ionic conductivity of the solid electrolyte based on the content of TMS-SH contained in the surface-modified composite solid electrolyte, first, a surface-modified composite solid electrolyte was prepared in the same manner as in Example 1, wherein the content of TMS-SH present in the THF solvent was changed to 0.05M, 0.1M, and 0.2M, respectively. The electrolyte thus prepared was applied to prepare the electrolyte pellet in the same manner as in Example 5.

Then, ionic conductivity was measured on the electrolyte pellets.

The results are shown in FIG. 7 and Table 1, and it was identified based on the results that the higher the concentration of TMS-SH, the lower the ionic conductivity. In general, the coating film becomes uniform as the amount of coating increases as the concentration of TMS-SH increases. In consideration of the ionic conductivity and the uniformity of the TMS-SH coating as found above, the results of measuring the ionic conductivity of the electrolyte pellets mean that the case of applying 0.1M of TMS-SH is most suitable.

The amount of TMS-SH forming the thin film layer actually adsorbed to the LPSCI when different concentrations of TMS-SH are applied may be estimated through ICP-AES analysis.

TABLE 1

| | Types of | | | |
|---|---|---|---|---|
| TMS-SH | elements in | | | |
| concentration | electrolytes | Li | P | Si |
| 0.05M | Molar ratio | 5.12 | 1 | 0.03 |
| 0.1M | | 5.974 | 1 | 0.094 |
| 0.2M | | 5.26 | 1 | 0.21 |

| | Molecular types | | |
|---|---|---|---|
| | in electrolytes | Li₆PS₅Cl | TMS-SH |
| 0.05M | Weight ratio | 1 | 0.02 |
| 0.1M | | 1 | 0.05 |
| 0.2M | | 1 | 0.11 |

1. A surface-modified composite solid electrolyte comprising:
a sulfide-based solid electrolyte particle; and
a coating film formed on a surface of the sulfide-based solid electrolyte particle, wherein the coating film contains a functional group derived from a chalcogen-based compound,
wherein the chalcogen-based compound is represented by a following Chemical Formula 1: 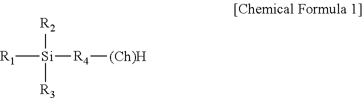
wherein in the Chemical Formula 1,
each of R₁ to R₃ independently represents a hydrogen atom or a monovalent linear or branched alkyl group having C₁ to C₁₀ carbon atoms,
R₄ represents a divalent linear or branched alkylene group having C₁ to C₁₀ carbon atoms,
Ch represents a chalcogen element.

2. The surface-modified composite solid electrolyte of claim 1,
wherein the sulfide-based solid electrolyte particle is made of a material represented by a following Chemical Formula 2: 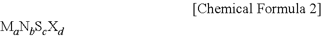
wherein in the Chemical Formula 2,
M is at least one selected from Li and Na,
N is at least one selected from the group consisting of P, B, Al, Ga, In, Si, Ge, Sn, Pb, Sb, Bi, Ti, V, Cr, Mn, Fe, Co, Ni, Cu, Y, Zr, Nb, Mo, Tc, Ru, Rh, Pd, Ag, Hf, Ta and W,
X is at least one selected from the group consisting of Cl, F, Br, I, O, Se, and Te,
0≤a≤8, 05b≤6, 0≤c≤11, and 0≤d≤6.

3. The surface-modified composite solid electrolyte of claim 1, wherein the sulfide-based solid electrolyte particle includes at least one selected from the group consisting of Li₆PS₅Cl, Li₃PS₄, Li₇P₃S₁₁, Li₆PS₅F, Li₆PS₅Br, Li₆PS₅I and Li₇P₂S₈I.

4. The surface-modified composite solid electrolyte of claim 1, wherein the coating film containing the functional group derived from the chalcogen-based compound has an average thickness of 1 to 10 nm.

5. The surface-modified composite solid electrolyte of claim 1, wherein the chalcogen-based compound is contained in a content of 2 to 8 parts by weight based on 100 parts by weight of the sulfide-based solid electrolyte particle.

6. The surface-modified composite solid electrolyte of claim 1, wherein after the surface-modified composite solid electrolyte has been stored in an oxygen atmosphere for at least 2 days, 70% or greater of an initial ionic conductivity thereof is maintained.

7. An all-solid-state battery comprising:
a composite positive electrode including a positive electrode active material and a conductive material; and
the surface-modified composite solid electrolyte according to claim 1.

8. The all-solid-state battery of claim 7, wherein the positive electrode active material is represented by a following Chemical Formula 3: 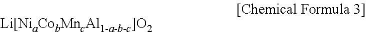
wherein in the Chemical Formula 3,
0≤a≤1, 0≤b≤1, and 0≤c≤1.

9. The all-solid-state battery of claim 7, wherein the positive electrode active material includes at least one selected from the group consisting of LiCoO₂, LiNiO₂, LiNi_{0.3}Mn_{0.3}Co_{0.3}O₂, LiNi_{0.3}Co_{0.3}Al_{0.3}O₂, and LiNi_{0.25}Co_{0.25}Mn_{0.25}Al_{0.25}O₂.

10. The all-solid-state battery of claim 7, wherein the conductive material includes at least one selected from the group consisting of natural graphite, artificial graphite, graphite, carbon black, acetylene black, Ketjen black, channel black, furnace black, lamp black, thermal black, carbon fiber, metal fiber, fluorinated carbon, aluminum, nickel powder, zinc oxide, potassium titanate, and titanium oxide.

11. The all-solid-state battery of claim 7, wherein a capacity of the all-solid-state battery after 2000 cycles is maintained at 80% or greater of an initial capacity.

12. The all-solid-state battery of claim 7, wherein the all-solid-state battery has coulombic efficiency maintained at 99% or greater for 2000 cycles.

13. The all-solid-state battery of claim 7, wherein a reversible capacity of the all-solid-state battery at a discharge rate of 4 C-rate under a charge rate of 0.1 C-rate is at least 60% of a reversible capacity thereof at a discharge rate of 0.1 C-rate under the charge rate of 0.1 C-rate.

14. A method for preparing a surface-modified composite solid electrolyte, the method comprising:
removing a solvent from a mixed solution including a chalcogen-based compound represented by a following Chemical Formula 1, the solvent, and sulfide-based solid electrolyte particles; and
drying a resultant product after removing the solvent, 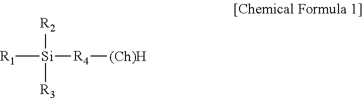
wherein in the Chemical Formula 1,
each of R₁ to R₃ independently represents a hydrogen atom or a monovalent linear or branched alkyl group having C₁ to C₁₀ carbon atoms,
R₄ represents a divalent linear or branched alkylene group having C₁ to C₁₀ carbon atoms,
Ch represents a chalcogen element.

15. The method for preparing the surface-modified composite solid electrolyte of claim 14, wherein the sulfide-based solid electrolyte particle is made of a material represented by a following Chemical Formula 2: 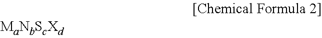
wherein in the Chemical Formula 2,
M is at least one selected from Li and Na,
N is at least one selected from the group consisting of P, B, Al, Ga, In, Si, Ge, Sn, Pb, Sb, Bi, Ti, V, Cr, Mn, Fe, Co, Ni, Cu, Y, Zr, Nb, Mo, Tc, Ru, Rh, Pd, Ag, Hf, Ta and W,
X is at least one selected from the group consisting of Cl, F, Br, I, O, Se, and Te,
0≤a≤8, 0≤b≤6, 0≤c≤11, and 0≤d≤6.

16. The method for preparing the surface-modified composite solid electrolyte of claim 14, wherein the sulfide-based solid electrolyte particle includes at least one selected from the group consisting of Li₆PS₅Cl, Li₇PS₄, Li₇P₃S₁₁, Li₆PS₅F, Li₆PS₅Br, Li₆PS₅I and Li₇P₂S₈I.

17. The method for preparing the surface-modified composite solid electrolyte of claim 14, wherein the solvent includes at least one selected from the group consisting of tetrahydrofuran (THF), N-methyl-2-pyrrolidone (NMP), acetone, ethanol, dimethyl acetamide (DMAc), and toluene.

18. The method for preparing the surface-modified composite solid electrolyte of claim 14, wherein the chalcogen-based compound represented by the Chemical Formula 1 is contained in a content of 8 to 12 parts by weight based on 100 parts by weight of the sulfide-based solid electrolyte particles.

19. The method for preparing the surface-modified composite solid electrolyte of claim 14, wherein the drying is performed under a vacuum at 30 to 50° C. for 10 to 14 hours.
